(19) United States
(12) Patent Application Publication
(10) Pub. No.: US 2025/0251718 A1
(43) Pub. Date: Aug. 7, 2025

(54) CHECKING SYSTEM AND RELATED METHOD FOR CHECKING A PRODUCTION PROCESS AND/OR CHARACTERISTICS OF A WORKPIECE

(71) Applicant: Marposs Societa' Per Azioni, Bentivoglio (IT)

(72) Inventors: Cesare MASETTI, Zola Predosa (BO) (IT); Antonio CREMONINI, Ferrara (IT); Antonio DE RENZIS, San Giorgio di Piano (BO) (IT); Marco BERTACCI, San Pietro in Casale (BO) (IT)

(21) Appl. No.: 18/855,689

(22) PCT Filed: Apr. 12, 2023
(86) PCT No.: PCT/EP2023/059511

§ 371 Date: Oct. 10, 2024

(30) Foreign Application Priority Data
Apr. 13, 2022 (IT) 102022000007355

(51) Int. Cl. G05B 19/418

(52) U.S. Cl. CPC G05B 19/4184; G05B 19/41855

(57) ABSTRACT

A checking system for checking a production process and/or characteristics of a workpiece is described. The checking system includes a plurality of sensor units and a network unit that are in communication with each other via a communication channel and form a network. The network unit communicates with a data processing and/or transmission entity. A checking method that enables all of the sensor units to download the most up-to-date software version each time the checking system is started up is also described.

### TECHNICAL FIELD

The present invention relates to a checking system comprising a plurality of electronic devices, more particularly sensor units, to check the characteristics of a workpiece, such as shape and/or size, or to check an industrial production process, and a related checking method.

The present invention can advantageously be used in distributed checking systems in industrial settings. A distributed system is a system comprising a plurality of electronic devices, and more specifically sensor units (called nodes) and a central management unit (called a bridge) that are connected together to form a communication network linked to a data processing and/or transmission entity (for example a computer, an industrial computer or PLC, a computer numerical control of a machine, or even a cloud network).

For example, the checking system and related method according to the invention can be used to check the machining of a mechanical workpiece in a machine tool, in a balancing system of a grinding wheel, to check the size and/or shape of a workpiece using contact or contactless sensors or probes, such as optical (interferometric, confocal, laser triangulation, etc.), acoustic or pneumatic sensors or probes, or to check temperature or vibration during machining of a workpiece.

The checking system and the related method according to the present invention can therefore be used to carry out checks before, after, and/or during the machining of a workpiece and/or in a production process, and can use different kinds of technologies.

### BACKGROUND ART

In industrial settings, it is known to use checking or measurement systems comprising a plurality of electronic devices, for example sensors, that are placed in close proximity to mechanical workpieces to be machined or inspected, and that enable the characteristics such as size and/or shape of such mechanical workpieces to be checked.

The sensors can be linked together, in different layouts, to form a network. Such a network usually includes a central management or interface unit that is connected to the different sensors and communicates with an external processor.

These are typically distributed systems in which each electronic device or sensor connected to the network includes a processor capable of processing and transmitting information. To work, the processor requires executable code (or firmware) kept in a storage device connected to the processor. This storage device may also be built into the processor.

The executable code is stored in a non-volatile manner (i.e. the code is not erased when the device is turned off) in the storage device.

During the lifetime of the system, the firmware of one or more devices may need to be upgraded to a newer version to fix bugs or to include new functionality.

A device may also need to be replaced with a new device running more recent firmware, for example following a fault. Incorporating such a new device is likely to cause compatibility issues between the firmware versions running on the different devices in the network. This has an impact at least on the reliability of the whole system.

Indeed, all devices belonging to the same network must have the same firmware version or at least mutually compatible firmware versions in order to work properly.

To overcome such problems, known solutions involve forcing firmware updates on all devices in the network by overwriting the non-volatile memory of these devices. However, this is a complex and often risky procedure that can damage the device irreparably, requiring such “bricked” devices to be replaced. More specifically, if the operation to update the firmware stored in the non-volatile memory (the same memory from which the firmware is read and executed on start-up) is interrupted for any reason (power cut, disturbance, etc.), the non-volatile memory may be left in an inconsistent state, i.e. the content is truncated and can no longer be executed correctly or at all when the system next restarts.

In some cases, this state can be detected using a checksum technique, enabling the device to return to the update phase. In other cases, however, the checksum technique cannot detect anomalies, and the truncated content of the non-volatile memory causes the processor to execute incorrect operations. In such critical cases, the device cannot return to the update phase, and the only recovery option is to wipe the non-volatile memory using special hardware tools. This is called “bricking” because the device loses all functionality and can only be used as a block of material, a paperweight, or a “brick”.

### DISCLOSURE OF THE INVENTION

The object of the present invention is to provide a checking system and method that overcome the drawbacks described above by efficiently and quickly providing all electronic devices or sensor units connected to the same network with the most up-to-date software version, and particularly firmware version, without causing slowdowns or downtime in the checking cycle.

The claims describe embodiments of the present invention and are an integral part of this description.

### BRIEF DESCRIPTION OF THE DRAWINGS

The present invention is described below with reference to the attached drawings, which show a non-limiting example embodiment of the invention, in which:

FIG. 1 is a schematic view of the checking system according to the invention as a whole,

FIG. 2 shows a component of the checking system in FIG. 1 in detail,

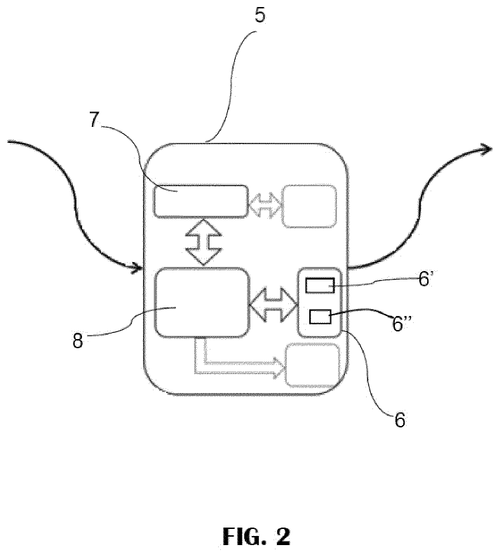

FIG. 3 is a diagram showing the steps of a checking method according to the present invention.

### BEST MODE FOR CARRYING OUT THE INVENTION

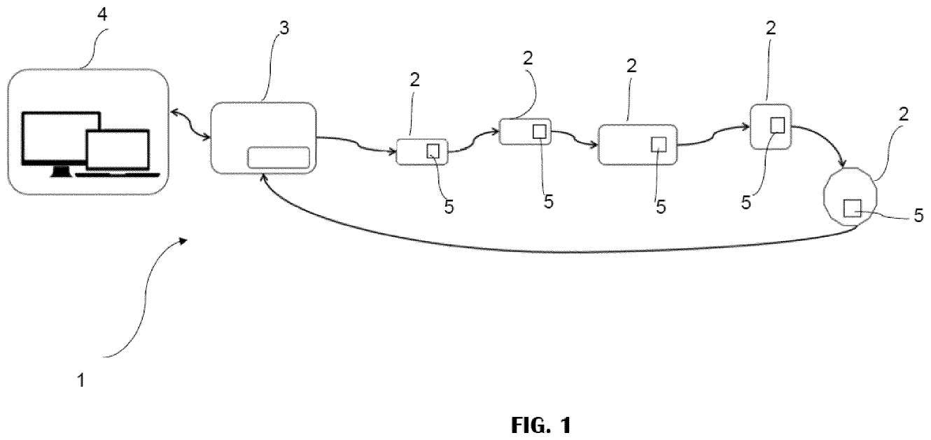

In FIG. 1, reference sign 1 denotes a checking system as a whole, said system comprising a plurality of electronic devices, more specifically sensor units 2 and a central management unit 3 that are connected to each other. The central management unit 3 is able to communicate with a data processing and/or transmission entity 4.

Such a data processing and/or transmission entity 4 may comprise, for example, a processor (such as a computer, an industrial computer or PLC for industrial process control, a computer numerical control of a machine) or computing infrastructure, which may also use cloud computing technology, depending on the application type.

The checking system 1 according to the invention is more specifically a distributed checking system in which the sensor units 2 represent individual network nodes and the central management unit 3 represents a network unit or bridge that connects the nodes and interfaces with the data processing and/or transmission entity 4 over a wired or wireless connection.

The sensor units (also called nodes) 2 and the central management unit (also called network unit or bridge) 3 are interconnected and form a communication network that can have different configurations, such as star, linear or other known configurations.

In the preferred embodiment shown in FIG. 1, the network has a linear configuration, and more specifically a daisy chain configuration, i.e. individual nodes 2 are connected sequentially by cable via a single communication channel (shown schematically with arrows), with the nodes at the ends of the “chain” being connected to the central management unit 3.

Preferably, the communication channel is a serial Ethernet channel. The communication channel can alternatively be a channel based on a different standard, such as USB, RS485, RS232, CAN bus or generic fieldbus.

According to a preferred embodiment (not shown in the figure), each node 2 is connected to the communication channel by a suitably sized T-shaped connector with a very small footprint.

As an alternative to the wired connection, the communication channel can be wireless.

The network can include any number of sensor units 2.

As mentioned above, the sensor units 2 connected to the network can be of the same or different types, can perform different checks (before, after and during the machining of a workpiece or the production process), and use different types of technologies.

For example, the network can comprise contact or contactless sensors or probes for dimensional and/or shape checking (for example implementing optical, acoustic, or pneumatic technology), sensors or probes for checking temperature or vibration during the machining of a workpiece or during the production process, cameras, devices for checking the machining of a mechanical workpiece in a machine tool, and systems for balancing a grinding wheel.

According to the present invention, each sensor unit or node 2 in the network is provided with a control and communication unit 5 that includes a processing unit 8, such as a processor or specifically a microprocessor, and a memory device 6.

The memory device 6 in turn includes a non-volatile memory device 6′ (for example a flash memory) and a volatile memory device 6″ (or random-access memory, RAM), shown schematically in the figure using rectangles.

The control and communication unit 5 of each node 2 also includes an interface element 7 that allows the node 2 to interface with the communication channel.

The memory device 6 can host the software of the control and communication unit 5.

Each node 2, and more specifically the microprocessor 8 of the control and communication unit 5 of each node 2, is provided with software, and more specifically firmware, comprising a service application, or bootloader, and a management application, both of which are designed to interface with the network unit 3 via the communication channel.

The service application is held in the non-volatile memory device 6′ and does not usually require updates. The function of the service application is to enable the node 2 to receive the current version of the management application each time the checking system 1 is turned on.

The management application is transmitted from the data processing and/or transmission entity 4 to all of the nodes 2 through the communication channel.

Preferably, the management application is distributed to all the nodes by the network unit 3.

According to a preferred embodiment, the management application sent by the data processing and/or transmission entity 4 is first stored in the network unit 3 and then distributed to all of the nodes 2.

The loading or downloading of the management application to each node 2 is made possible by special instructions that are executed both bridge-side and node-side, particularly by the service application of the latter.

According to a preferred embodiment, the management application for the sensor units 2 connected to the network is stored in the network unit 3, in a non-volatile memory and is not erased each time the checking system 1 is turned off.

The management application stored in the network unit 3 can be updated, modified and replaced by the data processing and/or transmission entity 4 using a dedicated procedure outside the normal checking cycle of the system, when a more up-to-date software version is available or when changes need to be made to the software.

The present invention also relates to a method for checking an industrial production process and/or characteristics of a workpiece, such as size and/or shape, using a plurality of sensor units 2 and a central management unit 3 connected together to form a network.

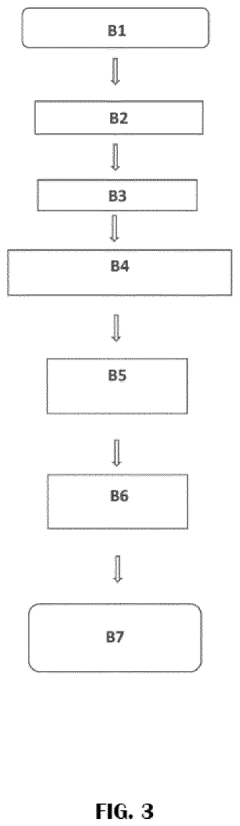

The steps of this method are described below with reference to a block diagram shown in FIG. 3.

Once the checking system 1 has been started (block B1), that is when the checking system 1 is powered up after a suspension or a period with no power supply, the service application (bootloader) of the microprocessor 8 of the control and communication unit 5 of each sensor unit 2 starts automatically (block B2) and places the microprocessor 8 of the control and communication unit 5 of each sensor unit 2 in standby (block B3) to receive the management application through the communication channel. In other words, the service application makes the control and communication unit (5) of each sensor unit (2) wait for the management application transmitted from the data processing and/or transmission entity (4) to be received through the communication channel.

According to a preferred embodiment, this step of the method defines a waiting state of the sensor unit 2.

The management application comprises executable code that includes a set of commands defined by an appropriate protocol to manage operation of the sensor unit 2 as a whole.

Different commands may be used depending on the functions of each sensor unit 2. There are specific commands in each case that enable the sensor unit 2 to interpret the data received from that instant onwards as a code to be executed once reception is complete.

The management application is received and written into the volatile memory device 6″ of the control and communication unit 5 of each sensor unit 2 (block B4). According to a preferred embodiment, this step of the method defines a receiving state of the sensor unit 2.

Specifically, the executable code that each sensor unit 2 in the checking system 1 is waiting to receive is represented by a file broken down into code packages that can be sent over the aforementioned communication channel.

The received code packages are written to the volatile memory device 6″ of the control and communication unit 5 of each sensor unit 2 in the form of executable code.

According to a preferred embodiment, each sensor unit 2 remains in the waiting state until the first code package is received from the management application.

Following the reception of the first code package, each sensor unit 2, or more precisely the microprocessor 8 of each sensor unit 2, switches to the receiving state, remaining on standby to receive all of the code packages subsequent to the first code package until reception is complete (the completion of reception can be identified in a known way by a specific value contained in a given code package). In other words, in the receiving state each sensor unit 2 waits for all the code packages following the first one until all code packages have been received.

In the receiving state, the received code packages are written to the volatile memory device 6″ of the control and communication unit 5 of each sensor unit 2.

Preferably, once the management application has been received, the microprocessor 8 of each sensor unit 2 performs an integrity check of the received management application, and more specifically of the received code packages, (block B5) using known techniques (for example checksum techniques, cyclic redundancy check (CRC) techniques, or the like). If this verification is unsuccessful, the verification is stopped and an error is reported to the network unit 3.

Once the management application has been received and, where provided for, the integrity check has been passed, the microprocessor 8 of each sensor unit 2 switches to the execution phase of the management application (block B6), and each sensor unit 2 executes the normal operating cycle, implementing the functions provided by the management application until the checking system 1 is turned off (block B7).

According to a preferred embodiment, each time the checking system 1 starts up, there is a self-learning phase in which the network unit 3 queries all of the sensor units 2 connected to the network to detect the number and/or type of sensor units connected. This phase is useful for the subsequent management application distribution operation.

As mentioned above, the structural difference between the checking system 1 according to the present invention and known systems is that the software (or firmware) that manages operation of the nodes 2 is loaded into the nodes 2 each time the checking system 1 is turned on or started up, whereas in known solutions such firmware is kept in a non-volatile memory in the nodes.

To update or change the firmware of nodes in known systems, it is therefore necessary to stop the operation of the entire system and to manually reprogram the firmware of the nodes that need updating or, where necessary, to reprogram the entire network.

Instead, in the measurement system according to the invention the use of a volatile memory 6″ in the control and communication unit 5 of each node 2 means that the software managing operation of the node 2 that has been temporarily stored in the control and communication unit 5 of each individual node 2, more specifically the management application, is erased each time the checking system 1 is turned off and is automatically loaded again into the control and communication unit 5 of each node 2 each time the checking system 1 is started up again.

The management application loaded into the control and communication unit 5 of each node 2 each time the checking system 1 is started is the version transmitted by the data processing and/or transmission entity 4) at that time.

This version may be the version loaded when the checking system 1 was started previously, if no changes have occurred in the meantime, or a more up-to-date or otherwise different version if a newer version or a version containing changes has been transmitted by the data processing and/or transmission entity 4 in the meantime.

As mentioned above, the management application that is loaded each time the checking system 1 is started and written to the volatile memory device 6″ is the software part of the microprocessor 8 that manages the entire operation of the node 2. The service application that is held in the non-volatile memory device 6″ and does not need to be loaded with each start-up of the system 1 represents a minimal software part that is used to receive the management application.

As mentioned above, different electronic devices or sensor units can be connected to the network. Each type of sensor unit 2 may correspond to a different management application. In this case, a different management application, more specifically different code packages corresponding to the management application, is/are transmitted by the data processing and/or transmission entity 4 for each type of sensor unit connected to the network.

Each time the checking system 1 starts up, the corresponding management application is distributed to each node 2.

According to preferred embodiment, the different code packages (corresponding to the management application) are stored in the network unit 3 for each type of node 2. When the checking system 1 starts up, the network unit 3 distributes the appropriate code packages to each node 2, said code packages being stored in the volatile memory device 6″ of the control and communication unit 5 of each node 2.

Regardless of any characteristics of the loaded management application that are dependent on the type of node 2 to which said management application relates, interoperability is guaranteed between all network components, i.e. the individual sensor units 2 and the network unit 3.

In other words, regardless of any characteristics that the management application may have depending on the type of sensor unit 2 whose operation has to manage, the capacity for dialogue and information exchange between the sensor units 2 and the network unit 3 connected to the network, as well as the ability to use this information and interact with each others to operate the network and the checking system 1 in general is guaranteed.

Since firmware can take up to several minutes to download, each power-up of the checking system 1 could result in significant waiting time.

According to a preferred embodiment, an extremely fast communication channel is used to overcome this drawback and to complete the loading of the firmware and therefore power-up of the checking system 1 in a negligible time imperceptible to the operator, this operation being completed in a matter of seconds.

Indeed, an Ethernet communication channel is implemented into the checking system 1 according to the invention to enable high-speed communication.

Specifically, the implementation according to the invention involves skipping several layers of the protocol software normally used in Ethernet channels, thereby optimizing performance in terms of transmission bandwidth.

More specifically, the lowest level of Transmission Control Protocol/Internet Protocol (TCP/IP) was used, stopping at protocol level 2 of the International Standardization Organization/Open Systems Interconnection (ISO/OSI) Model.

A proprietary protocol was added to this protocol.

In other words, the Ethernet communication channel used in the present invention implements up to the layer 2 protocol of the ISO/OSI reference model, and a proprietary protocol has been used for the upper layers of said reference model.

Since there are no mechanisms for encapsulation or retransmission of code packages, the Ethernet channel is essentially used in the same way as a Universal Asynchronous Receiver-Transmitter (UART) device, very efficiently in terms of actual transmission capacity or throughput.

In addition to a high connection speed between network components, the communication channel used in the present invention also has advantages in terms of measurement acquisition speed and number of measurement points. In a network with a hundred nodes, for example, up to 4500 measurements can be acquired per second.

An additional advantage of the checking system 1 according to the present invention is that the use of volatile memory devices obviates the risks related to the forced updating of system components, an operation that can cause bricking or, more generally, permanent damage to electronic devices in the network.

Another advantage is the option of setting the behaviour of each node 2 in the related measurement cycle each time the checking system 1 is started up. If a node can perform several functions, it is possible to set which type of check the node should perform in that particular checking cycle. The management application distributed at each start-up of the checking system 1 and loaded into a given node 2 contains the instructions necessary to start the functions of said node 2 that are required for the type of check to be performed. In other words, the management application received from the control and communication unit 5 of each sensor unit 2 selectively enables the functions of that sensor unit 2 as required for the specific checking cycle.

For example, a sensor unit that performs dimensional checks and includes an HBT transducer can use the same hardware also to perform a temperature check, in a known manner. When the checking system 1 starts up, the data processing and/or transmission entity 4 or the network unit 3 determines which type of check the specific sensor unit should perform in that specific checking cycle and, depending on requirements, sends the management application containing the necessary instructions to that sensor unit to perform one of the two checks.

According to an alternative embodiment, data related to operation of the sensor unit 2 can also be stored in the non-volatile memory device 6′ in the control and communication unit 5 of each sensor unit 2. In the case of a sensor unit 2 performing dimensional checks, for example, the stored data may include calibration and linearization data.

The data stored in such a non-volatile memory device 6′ are not erased when the checking system 1 is turned off and can be changed when necessary, using appropriate commands.

In the checking system 1 described so far, the central management unit 3 is a component separate from the other system components. Alternatively, the central management unit 3 can be built directly into the data processing and/or transmission entity 4 while continuing to function as a network unit.

Since in the checking system 1 according to the invention the firmware of all of the nodes 2 connected to the same network is loaded at each start-up of the checking system 1, a high degree of mutual compatibility between network components is guaranteed.

This overcomes the incompatibility issues typical of known systems and related to the replacement of nodes that are no longer functioning or that need to be replaced, for example due to the requirements of the check to be carried out, with nodes with a firmware version that is more up-to-date or in any case different from the firmware version in the other nodes of the system and that are not compatible with the rest of the devices already connected to the network.

The checking system 1 according to the invention also has an extremely high degree of flexibility and scalability.

According to a preferred embodiment, the checking system 1 according to the invention is capable of automatically reconfiguring itself at each start-up. As explained above with reference to the checking method, the network unit 3 can perform a check on the number and/or type of nodes 2 connected to the network, i.e. a self-learning operation of the network state, when the checking system 1 is started up. This allows the network unit 3 to understand which nodes 2 are connected to the network, whether one or more nodes have been disconnected, or conversely whether any nodes have been replaced or added. Based on the outcome of this verification, the network unit distributes the management application required for operation of the individual nodes, and therefore operation of the checking system 1, to the individual nodes 2.

The network unit 3 can select and distribute the software stored in said network unit in a separate phase from the checking cycle. As mentioned earlier, the software contained within the network unit 3 is modified by means of the data processing and/or transmission entity 4 before the start of the checking cycle.

The memory device 6 inside the control and communication unit 5 of each individual node 2 can be connected to the microprocessor 8, as shown in the drawings, or be built into the microprocessor 8.

As explained, each sensor unit 2 has a control and communication unit 5 that enables the sensor unit 2, among other things, to interface with the network and thus to connect to and dialogue with the other sensor units 2 and the network unit 3. Such a control and communication unit 5 can either be built into the sensor unit 2 or be external and connected thereto by connection means, such as a length of cable. Preferably, the connection between the sensor unit 2 and the corresponding control and communication unit 5 cannot be disconnected. Where outside the sensor unit 2, the control and communication unit 5 is preferably placed close to the sensor unit 2.

An additional advantage of the checking system 1 according to the present invention is the ability to use the same hardware for all control and communication units 5 regardless of the type of sensor unit 2 with which the control and communication unit 5 is used.

When built into the sensor unit 2, the control and communication unit 5 is preferably built into the electronics of the sensor unit 2 that controls operation of the sensor unit 2.

As mentioned earlier, the checking system 1 according to the present invention may include electronic devices designed to check characteristics of workpieces, such as size and/or shape, among other device types.

Such electronic devices may for example include axial linear gauging heads, also called pencil probes, which typically comprise a cylindrical spindle that slides axially in a longitudinal direction inside a casing, by means of a guiding device, and with a feeler at one end that is adapted to touch the workpiece to be checked.

The casing also contains a transducer connected at least partially to the same spindle, for example at the end opposite the end with the feeler, which allows the displacements of the feeler, and consequently of the spindle, to be measured in a known manner following contact with the workpiece to be checked.

The transducer can be an inductive transducer, such as a linear variable differential transducer (LVDT) or, preferably, a half bridge transformer (HBT), and provide an analogue signal as a function of feeler displacement, in a known manner. Transducers implementing different technologies, such as optical, magnetic, capacitive, or other transducers can also be used.

According to a preferred embodiment, the gauging head is equipped with electronics designed to receive the output signal from the transducer and transform said signal into a digital signal in a known manner. These electronics also include the control and communication unit 5 that enables the gauging head to interface with the network. The control and communication unit is then built into the gauging head and arranged inside the casing of said gauging head.

Alternatively, the control and communication unit 5 can be arranged in an element external to the gauging head, usually located near the gauging head and connected thereto by a cable or other connection means.

As described above, the output signal from an individual node 2 is preferably digital, regardless of device type. This ensures greater immunity to noise and the good quality of the transmitted signal regardless of the signal path length.

Positioning the control and communication unit 5, which enables connection to and dialogue with the network, outside an individual sensor unit 2 makes it possible to connect electronic devices to the network as nodes even where such electronic devices are not inherently or technologically able to interface with the network and other devices connected thereto.

According to a preferred embodiment, the sensor units 2 connected to the network are provided with a temperature sensor to measure the temperature changes occurring inside the sensor unit 2 during the checking cycle, regardless of the check said sensor units are intended to perform. Thermal compensation may also be implemented using an appropriate firmware configuration.

1. A checking system for checking an industrial production process and/or characteristics of a workpiece, the checking system comprising:
a network unit configured to communicate with a data processing and/or transmission entity;
a plurality of sensor units in communication with each other and to the network unit, each of the plurality of sensor units including a control and communication unit comprising a processing unit, a memory device storing software configured to execute on the processing unit, and an interface element; and
a communication channel connecting the plurality of sensor units and the network unit, wherein:
the memory device comprises a non-volatile memory device and a volatile memory device,
the software includes a management application managing operation of the sensor unit on which the software is stored and a service application enabling the processing unit to receive the management application,
the service application is stored in the non-volatile memory device and is configured to start automatically when the checking system starts up, and
the management application is transmitted from the data processing and/or transmission entity and written to the volatile memory device every time the checking system starts up.

2. The checking system of claim 1, wherein the management application is distributed by the network unit to each of the plurality of sensor units each time the checking system starts up.

3. The checking system of claim 1, wherein the communication channel is an Ethernet communication channel.

4. The checking system of claim 3, wherein the Ethernet communication channel implements up to the layer 2 protocol of the ISO/OSI (International Standardization Organization/Open Systems Interconnection) reference model.

5. The checking system of claim 4, wherein a proprietary protocol is implemented for the upper layers of the ISO/OSI reference model.

6. The checking system of claim 1, wherein the control and communication unit is built into each of the plurality of sensor units.

7. The checking system of claim 1, wherein the control and communication unit is connected to each of the plurality of sensor units via a connection element.

8. The checking system of claim 1, wherein the management application includes a plurality of code packages including a first code package, and the control and communication unit of each of the plurality of sensor units is configured to:
enter a waiting state, after the automatic start of the service application, to wait for the management application to be received through the communication channel;
switch from the waiting state to a receiving state, after reception of the first code package of the management application, in which all of the plurality of code packages following the first code package of the management application are received and written to the volatile memory device of the control and communication unit; and
execute the management application until the checking system turns off.

9. A checking method for checking an industrial production process and/or characteristics of a workpiece using a checking system comprising a network unit configured to communicate with a data processing and/or transmission entity and a plurality of sensor units in communication with each other and to the network unit via a communication channel, each of the plurality of sensor units including a control and communication unit comprising a processing unit, a memory device that comprises a non-volatile memory device and a volatile memory device and that stores a software including a service application and a management application, and an interface element, the method comprising:
starting the checking system;
automatically starting the service application that is stored in the non-volatile memory device;
causing, via the service application, the control and communication unit to wait for the management application transmitted from the data processing and/or transmission entity to be received through the communication channel;
storing the management application on the volatile memory device; and
executing the management application via the processing unit until the checking system turns off.

10. The checking method of claim 9, wherein;
the management application includes a plurality of code packages including a first code package;
causing the control and communication unit to wait for the management application to be received defines a waiting state of each of the plurality of sensor units;
storing the management application on the volatile memory device defines a receiving state of each of the plurality of sensor units;
each of the plurality of sensor units remains in the waiting state until the first code package of the management application is received; and
after receiving the first code package of the management application, each of the plurality of sensor units switches to the receiving state to wait for all of the plurality of code packages following the first code package until all of the plurality of code packages have been received.

11. The checking method of claim 9, further comprising checking, after reception of the management application, the integrity of the management application.

12. The checking method of claim 9, further comprising implementing, after the checking system starts up, a self-learning phase in which the network unit queries all the plurality of sensor units to detect the number and/or type of the plurality of sensor units.

13. The checking method of claim 9, wherein the management application received by the control and communication unit is distributed by the network unit.

14. The checking method of claim 13, wherein the management application distributed by the network unit is stored in another non-volatile memory device within the network unit.

15. The checking method of claim 9, wherein the management application received by the control and communication unit selectively enables at least one function of each of the plurality of sensor units.

16. (canceled)
